(19) United States
(12) Patent Application Publication
(10) Pub. No.: US 2018/0327290 A1
(43) Pub. Date: Nov. 15, 2018

(54) METHOD FOR REDUCING CHEMICAL OXYGEN DEMAND OF WASTEWATER FROM PREPARATION OF 2-ETHYLHEXANOL

(71) Applicant: NAN YA PLASTICS CORPORATION, Taipei (TW)

(72) Inventors: Te-Chao LIAO, Taipei (TW); Jung-Jen CHUANG, Taipei (TW); Chiou-Nan LAI, Taipei (TW); Zhang-Jian HUANG, Taipei (TW); Yi-Cheng LI, Taipei (TW)

(21) Appl. No.: 15/970,004

(22) Filed: May 3, 2018

(30) Foreign Application Priority Data
May 10, 2017 (TW) 106115413

(51) Int. Cl. C02F 1/66; C02F 1/26; C02F 1/04

(52) U.S. Cl. CPC C02F 1/66; C02F 2103/365; C02F 1/04; C02F 1/26

(57) ABSTRACT

A method is disclosed for use in reducing chemical oxygen demand (COD) of alkaline wastewater generated from an aldol condensation reaction during a process for preparing 2-ethylhexanol, which teaches both high-boiling-point aldol mixtures and low-boiling-point aldol mixtures are used to serve as an extractant for reducing COD in the wastewater, and further to perform a stripping treatment, thereby a removal rate of COD in the wastewater of 89-93% is then achieved.

### BACKGROUND OF THE INVENTION

### 1. Field of the Invention

The present invention relates to a method for treating wastewater of aldol condensation reaction, and more particularly to a method for reducing COD (chemical oxygen demand) of wastewater from preparation of 2-ethylhexanol, and the removal rate of COD in the wastewater is improved by more than 89-93%.

### 2. Description of Related Art

Process for preparing 2-ethylhexanol (or called isooctanol) is started from a formylation reaction between propylene and syngas (i.e., a gas prepared by mixing carbon monoxide and hydrogen with a mole ratio of 1:1) to obtain a mixture of isobutyraldehyde and n-butyraldehyde.

After isobutyraldehyde and n-butyraldehyde are separated, the isobutyraldehyde undergoes a hydrogenation reaction, and then, by removal of a low-boiling-point aldol mixture and a high-boiling-point aldol mixture, an isobutanol product with high purity is obtained.

The n-butyraldehyde is subjected to an aldol condensation reaction in the presence of an alkaline catalyst (such as a sodium hydroxide aqueous solution) to produce a 2-ethylhexenal with the same equivalent amount of wastewater. For maintaining the balanced concentration of the alkaline catalyst, the alkaline catalyst has to be continuously replenished and alkaline wastewater has to be drained regularly.

The 2-ethylhexenal undergoes a hydrogenation reaction, and then, by removal of a low-boiling-point aldol mixture and a high-boiling-point aldol mixture, a 2-ethylhexanol product with high purity is obtained.

During process for preparing 2-ethylhexanol, those by-products such as low-boiling-point aldol mixtures and high-boiling-point aldol mixtures are respectively come from proceeding process for purification and isolation of the isobutanol product and the 2-ethylhexanol product. Those said by-products are mainly used as fuel. Some of the low-boiling-point aldol mixtures may be used to extract n-butanol and has relatively low economic value.

As mentioned above, when n-butyraldehyde is subjected to an aldol condensation reaction with an alkaline catalyst to produce a 2-ethylhexenal, it is required during process for producing the aldol condensation reaction to continue adding alkaline catalysts and continue discharging alkaline wastewater (hereinafter referred to as wastewater). However, the discharged wastewater has high organic content and COD (chemical oxygen demand) in the wastewater can be as high as 20,000 to 50,000 mg/L. Accordingly, before wastewater is introduced into either wastewater treatment plants or other wastewater treatment facilities for decontamination, large amounts of organic impurities must be removed from the wastewater, such that the concentration of pollutants in the discharged wastewater for decontamination is lower than that of the highest concentration of pollutants that can be accepted and treated by the wastewater treatment plants or the wastewater treatment facilities.

To increase the removal rate of COD in the wastewater, the prior art teaches the following treatment method for removing COD in the wastewater.

U.S. Pat. No. 6,358,419 teaches a process for the purification of alkaline wastewater from the aldol condensation reaction using acidification and extraction. The extractant is selected as an alcohol having at least eight carbon atoms or a hydrocarbon having at least six carbon atoms, and the removal rate of COD in the wastewater is more than 80% in average. In practice, the extractant may be a 2-ethylhexanol, since the 2-ethylhexanol has high economic value and is recycled using distillation. However, with increase of times of extraction, more and more middle and high-boiling-point organic impurities are transferred from wastewater to the extractant, and the temperature required for recycling the extractant through distillation becomes higher and higher, leading to significant energy consumption and lowered extractant recovery rate.

U.S. Pat. No. 6,139,747 also teaches a process for cleaning up alkaline wastewaters from the aldol condensation reaction using acidification and extraction. The extractant is specified as an alcohol having at least eight carbon atoms or a hydrocarbon having at least six carbon atoms. The acidified wastewater has some water-insoluble, high-boiling-point matters filtered out using a coalescing filter before extraction, so as to mitigate the need of continuously increasing the temperature for distillation after repeated extraction. However, this known method still fails to solve the problems about high energy consumption and lower extractant recovery rate.

A prior-art method is known to disclose a process where alkaline wastewater from the aldol condensation reaction is acidified and set aside for phase separation, and then the water-insoluble, high-boiling-point organic components (in the oil phase) are recovered and added into the aqueous phase as an extractant. While there is no need to recycle the extractant in this prior-art method, the extractant is limited in its ability to dissolve organic components in wastewater after repeated use. Treatment according to this known method can only give a removal rate of COD in the wastewater ranged from 50% to 65% from the aldol condensation reaction, and the effectiveness therefore must be improved.

Another prior-art method is known to disclose a method for treating alkaline wastewater from aldol condensation reaction wherein the alkaline wastewater is acidified, extracted with a high-boiling-point aldol mixture having 8, 12, 16 or more carbon atoms as process by-product, and put into oil-water separation to yield wastewater with reduced COD. Since the organic matters contained in the wastewater are complicated and widely inconsistent in their boiling points, the use of only the high-boiling-point aldol mixture as the extractant has limited effectiveness in dissolving the organic components in the wastewater. Treatment according to this known method can only give a COD removal rate of 50-55% for the alkaline wastewater from aldol condensation reaction, and the effectiveness has to be improved.

U.S. Pat. No. 7,943,047 teaches a process for the treatment of wastewater from aldolization processes, wherein alkaline wastewater from aldol condensation reaction is acidified and optionally extracted before getting stripped. The low-boiling-point aldol mixture and water in the condensate collected at the top of a stripping apparatus receives oil-water separation and a low-boiling-point aldol mixture is recycled for use as an extractant in extraction of the acidified wastewater. The wastewater with reduced COD harvested at the bottom of the stripping apparatus has a COD removal rate of 85-88%. The extractant used in this known method is mainly sourced from wastewater by stripping. In the initial phrase and during operation, an additional low-boiling-point aldol mixture has to be added so as to maintain the relative proportion between the extractant and the wastewater and in turn the stability for continuous operation. Hence, there is a need for a method that guarantees stable, continuous operation of wastewater treatment, and provides high COD removal rate.

### SUMMARY OF THE INVENTION

The primary objective of the present invention is to provide a method for treating wastewater from aldol condensation reaction, and the wastewater is particularly alkaline wastewater from aldol condensation reaction that produces 2-ethyl hexenal during preparation of 2-ethylhexanol. The method comprises the following steps:
1) adding an inorganic acid to the alkaline wastewater to make a pH value of the wastewater be of 0-4, and preferably 0-2;
2) extracting the acidified wastewater with a high-boiling-point aldol mixture as the by-product of the preparation of 2-ethylhexanol;
3) extracting the previously extracted, acidified wastewater with a low-boiling-point aldol mixture as a by-product of the preparation of 2-ethylhexanol; and
4) stripping the extracted, acidified wastewater to effectively reduce the chemical oxygen demand (COD) of the wastewater.

In the present invention, the high-boiling-point and low-boiling-point aldol mixture continuously produced during the preparation of 2-ethylhexanol can be directly used as the extractant. In the initial phrase of operation or during operation of wastewater treatment, the disclosed method helps to stably maintain certain relative proportions between the extractants and the wastewater, thereby improving continuous operation stability of wastewater treatment. In addition, since the organic matters contained in the wastewater are complicated and widely inconsistent in their boiling points, use of high-boiling-point and low-boiling-point aldol mixtures in succession as extractants can effectively improve solubility of organic components in wastewater during extraction, further increasing the COD removal rate for the wastewater to 89-93%.

The extractants used in the present invention are by-products having less economic value, and this helps to reduce the costs for wastewater treatment, thereby improving wastewater treatment in terms of economy.

### DETAILED DESCRIPTION OF THE INVENTION

The present invention provides a method for reducing chemical oxygen demand of alkaline wastewater which is generated from an aldol condensation reaction during a process for preparing 2-ethylhexanol, and teaches both high-boiling-point aldol mixtures and low-boiling-point aldol mixtures are used to serve as an extractant for reducing COD in the wastewater.

The process for preparation of 2-ethylhexanol is achieved by first producing a mixture of isobutyraldehyde and n-butyraldehyde through formylation reaction between propylene and a syngas; separating isobutyraldehyde and n-butyraldehyde; hydrogenating isobutyraldehyde; and removing low-boiling-point and high-boiling-point aldol mixtures therefrom. The resulting isobutanol product is of high purity.

The n-butyraldehyde can be aldolized with the presence of an alkaline catalyst (such as a sodium hydroxide aqueous solution) to yield 2-ethylhexenal and one equivalent of water. For maintaining a certain concentration of the alkaline catalyst, continuous replenishment of the alkaline catalyst and regular draining of alkaline wastewater are required. After hydrogenation reaction of 2-ethylhexenal, low-boiling-point aldol mixtures and high-boiling-point aldol mixtures are removed to produce a 2-ethylhexanol product of high purity.

The method for reducing chemical oxygen demand of wastewater from preparation of 2-ethylhexanol of the present invention, comprising steps of:
1) adding an inorganic acid to alkaline wastewaters produced from process for preparing of 2-ethylhexanol;
2) extracting the wastewater acidized in Step 1) with the high-boiling-point aldol mixture as an extractant;
3) extracting the acidized wastewater extracted in Step 2) with the low-boiling-point aldol mixture as an extractant; and
4) introducing the acidified wastewater after extracted in Step 3) to a distillation column to perform a stripping treatment, thereby achieving a removal rate of COD in the wastewater of 89-93%.

In the disclosed method, the inorganic acid used in Step 1) may be hydrochloric acid, sulfuric acid, phosphoric acid or nitric acid, wherein sulfuric acid is preferable. The alkaline wastewater is acidified by the inorganic acid and has its pH value become 0-4, and preferably 0-2.

In the disclosed method, the extractants used in Steps 2) and 3) are high-boiling-point aldol mixture (hereinafter referred to as the first extractant) and low-boiling-point aldol mixture (hereinafter referred to as the second extractant) continuously produced during the preparation of 2-ethylhexanol.

The first extractant comes from refinement of crude isobutanol and crude 2-ethylhexanol during preparation of 2-ethylhexanol. The first extractant (i.e. the high-boiling-point aldol mixture) has a composition containing the following components with a total weight percent of 100%:
a) an alcohol or an aldehyde having four carbon atoms, 0-5 wt %;
b) an alcohol or an aldehyde having eight carbon atoms, 20-25 wt %;
c) an alcohol or an aldehyde having at least nine carbon atoms, 70-80 wt %; and
d) water, 0-1 wt %.

The second extractant comes from refinement of crude isobutanol and crude 2-ethylhexanol during preparation of 2-ethylhexanol. The second extractant (i.e. the low-boiling-point aldol mixture) has a composition containing the following components with a total weight percent of 100%:
a) n-butanol, 60-70 wt %;
b) an alcohol or an aldehyde having four carbon atoms, 0-5 wt %;
c) an alcohol or an aldehyde having eight carbon atoms, 10-20 wt %;
d) an alcohol or an aldehyde having at least nine carbon atoms, 0-5wt %; and
e) water, 5-15wt %;

In the disclosed method, the extraction of Step 2) is performed by using the first extractant to extract the acidified wastewater. A weight ratio of the first extractant to the wastewater ranges from 1:1 to 1:12, and preferably from 1:1 to 1:6.

The first extractant after extraction can be directly returned to a by-product silo without purification and regeneration.

In the disclosed method, the extraction of Step 3) is performed by using a second extractant to extract the wastewater that has been extracted using the first extractant. A weight ratio of the second extractant to the wastewater ranges from 1:1 to 1:45, and preferably from 1:1 to 1:15.

The second extractant after extraction can be directly returned to a by-product silo without purification and regeneration.

The extraction in the present invention is performed using a known extraction device, which may be a packed column extractor or a set of mixers and separators that are connected in series. The mixer may be a static or dynamic mixer, a stirrer or a pump. The separator set may be decanters, oil droplet coalescer, or centrifugal separators.

In the disclosed method, the stripping of Step 4) is performed by introducing the post-extraction wastewater into a distillation column (also known as a stripping column) from its top, and feeding a stripping medium from the bottom of the distillation column. The stripping medium may be steam or an inert gas (such as nitrogen), but steam is more preferred.

The stripping is performed at an operation temperature of 80-180° C. (i.e. the temperature at the gaseous phase outlet), preferably 90-150° C., and more preferably 90-130° C. and at an operation pressure of 0.5-4.5 kg/cm² (i.e. the pressure at the gaseous phase outlet), preferably 0.5-2.75 kg/cm², and more preferably 1.0-2.4 kg/cm².

The steam condenses at the top of the distillation column, and the condensate is introduced into a decanter to have separate organic and aqueous phases. The aqueous phase is re-circulated and introduced into the top of the distillation column, while the organic phase is directly introduced into a by-product silo. The treated wastewater with reduced COD is then collected at the bottom of the distillation column

The following examples are described for further explaining the present invention, but those examples are not intended to limit the scope of the present invention.

### Measurement of Chemical Oxygen Demand (COD) of Wastewater

Excessive potassium dichromate solution is added into the water sample, and the sample is refluxed in a solution of 50% sulfuric acid. The remaining potassium dichromate is titrated with ferrous ammonium sulfate, and the chemical oxygen demand (COD) of the water sample is derived from its consumption of potassium dichromate.

### EXAMPLE 1

The alkaline wastewater having a pH value of 12.8 from aldol condensation reaction for preparation of 2-ethylhexanol was used for the Example. 900 g of the wastewater (with a COD of 26,717 mg/L) is taken to add with concentration of 95 mass % concentrated sulfuric acid, and to make the pH value of the wastewater become 1.2.

The acidified wastewater was added with 900 g of the high-boiling-point aldol mixture as the by-product of the preparation of 2-ethylhexanol and mixed them well. The high-boiling-point aldol mixture contained an alcohol or an aldehyde having four carbon atoms (weight ratio: 2.6%), an alcohol or an aldehyde having eight carbon atoms (weight ratio: 22.3%), an alcohol or an aldehyde having at least nine carbon atoms (weight ratio: 74.9%), and water (weight ratio: 0.2%).

The wastewater after extraction was treated for phase separation, and to the resulting aqueous phase, 900 g of the low-boiling-point aldol mixture as the by-product of the preparation of 2-ethylhexanol was added, and mixed them well. The low-boiling-point aldol mixture contained an aldehyde having four carbon atoms (weight ratio: 3.5%), n-butanol (weight ratio: 69.6%), an alcohol or an aldehyde having eight carbon atoms (weight ratio: 16.6%), an alcohol or an aldehyde having at least nine carbon atoms (weight ratio: 1.4%), and water (weight ratio: 8.9%).

The wastewater after two times of extraction was further treated for phase separation. Then the resulting aqueous phase was introduced to enter a distillation column from a top of the distillation column Stripping was conducted with the temperature and pressure at the outlet of the gaseous phase controlled at the levels shown in Table 1. To this end, steam was introduced into the column from bottom to vaporize the wastewater to have the vaporizer condense at the top of the column. Then, as shown in Table 1, the treated wastewater was collected at the bottom of the distillation column with its COD down to 1,897 mg/L and a removal rate of COD in the wastewater of 92.9%,

### EXAMPLES 2-5

Similar to Example 1, to 900 g of the wastewater (with a COD of 26,717 mg/L), concentration of 95 mass % concentrated sulfuric acid was added to make the pH value of the wastewater become 1.2. To the acidified wastewater, the high-boiling-point aldol mixture as the by-product of the preparation of 2-ethylhexanol was added in the amounts shown in Table 1, such as 225 g for Example 2, 150 g for Example 3, 75 g for Example 4, and 60 g for Example 5, and mixed well. The high-boiling-point aldol mixture contained: an alcohol or an aldehyde having four carbon atoms (weight ratio: 2.6%), an alcohol or an aldehyde having eight carbon atoms (weight ratio: 22.3%), an alcohol or an aldehyde having at least nine carbon atoms (weight ratio: 74.9%), and water (weight ratio: 0.2%).

The wastewater after extraction was treated for phase separation, and to the resulting aqueous phase, the low-boiling-point aldol mixture as the by-product of the preparation of 2-ethylhexanol was added in the amounts shown in Table 1, such as 225 g for Example 2, 60 g for Example 3, 20 g for Example 4, and 18 g for Example 5, and mixed well. The low-boiling-point aldol mixture contained: an aldehyde having four carbon atoms (weight ratio: 3.5%), n-butanol (weight ratio: 69.6%), an alcohol or an aldehyde having eight carbon atoms (weight ratio: 16.6%), an alcohol or an aldehyde having at least nine carbon atoms (weight ratio: 1.4%), and water (weight ratio: 8.9%).

The wastewater after two times of extraction was further treated for phase separation. Then the resulting aqueous phase was introduced to enter a distillation column from a top of the distillation column. Stripping was conducted with the temperature and pressure at the outlet of the gaseous phase controlled at the levels shown in Table 1. To this end, steam was introduced into the column from bottom to vaporize the wastewater to have the vaporizer condense at the top of the column. Then the treated wastewater was collected at the bottom of the distillation column and measured for its COD value and COD removal rate (against the original COD value of 26,717).

Then, as shown in Table 1, the treated wastewater was collected at the bottom of the distillation column with its COD down to 1,9407 mg/L and a removal rate of COD in the wastewater of 92.7% for Example 2, 2,565 mg/L and a removal rate of COD in the wastewater of 90.4% for Example 3, 2,779 mg/L and a removal rate of COD in the wastewater of 89.6% for Example 4, and 2,218 mg/L and a removal rate of COD in the wastewater of 91.7% for Example 5.

### COMPARATIVE EXAMPLE 1

Shown in Table 1, to 900 g of the wastewater the same as that used in Example 1, concentrated sulfuric acid (95%) was added to make the pH value of the wastewater become 1.2. The acidified wastewater was set aside for oil-water separation. Then the resulting aqueous phase was measured, and it was found that the COD value decreased to 19,502 mg/L and a removal rate of COD in the wastewater of 27%.

### COMPARATIVE EXAMPLE 2

Shown in Table 1, except that the extraction was performed without the low-boiling-point aldol mixture as the by-product of the preparation of 2-ethylhexanol and that no steam stripping was performed, all the others were the same as Example 4. The treated wastewater had a COD down to 15,416 mg/L and a removal rate of COD in the wastewater of 42.3%.

### COMPARATIVE EXAMPLE 3

Shown in Table 1, except that the extraction was performed without the low-boiling-point aldol mixture as the by-product of the preparation of 2-ethylhexanol, all the others were the same as Example 4. The treated wastewater had a COD down to 11,969 mg/L and a removal rate of COD in the wastewater of 55.2%.

### COMPARATIVE EXAMPLE 4

Shown in Table 1, except that the extraction was performed without the high-boiling-point aldol mixture as the by-product of the preparation of 2-ethylhexanol, all the others were the same as Example 4. The treated wastewater had a COD down to 4,320 mg/L and a removal rate of COD in the wastewater of 83.8%.

### COMPARATIVE EXAMPLE 5

Shown in Table 1, the whole process was the same as Example 1, except that the high-boiling-point aldol mixture and the wastewater had a weight ratio of 1:15, and the low-boiling-point aldol mixture and the wastewater had a weight ratio of 1:50. All the other steps were the same as Example 4. The treated wastewater had a COD down to 3,393 mg/L and a removal rate of COD in the wastewater of 87.3%.

### Results

1. In Examples 1 through 5, the high-boiling-point and low-boiling-point aldol mixtures were used to extract the wastewater. As demonstrated by the results, good COD removal efficiency happened when the weight ratio between the high-boiling-point aldol mixture and the wastewater of 1:1-12 while the best COD removal rate happened at the ratio of 1:1-6.

For the low-boiling-point aldol mixture, the weight ratio of 1:1-45 showed good COD removal efficiency while the best COD removal rate happened at the ratio 1:1-15.
2. In Comparative Example 1 where no high-boiling-point and low-boiling-point aldol mixtures were used to extract the wastewater, the resulting COD removal rate was low. In Comparative Examples 2 through 4, only one of the high-boiling-point and low-boiling-point aldol mixtures was used to extract the wastewater, and the results of reduction of the COD removal rate were not satisfying. This results emphasis the fact that using both high-boiling-point and low-boiling-point aldol mixtures to extract the wastewater can leverage the synergy of both to achieve better COD removal.
3. In Comparative Example 5, the wastewater was extracted using the high-boiling-point aldol mixtures and low-boiling-point aldol mixtures in ratios of 1:15 and 1:50, respectively. The adding amounts of the high-boiling-point aldol mixtures and low-boiling-point aldol mixtures were low and the proportion of the wastewater was high. The resulting COD removal rate was unsatisfyingly 87.3%.

TABLE 1

| | | | Example | | | | |
|---|---|---|---|---|---|---|---|
| | | | 1 | 2 | 3 | 4 | 5 |
| Process for | Acidification | | yes | yes | yes | yes | yes |
| reducing COD | First extraction; | 1/1 | yes | — | — | — | — |
| in wastewater | Usage amount of the | 1/4 | — | yes | — | — | yes |
| | first extractant by | 1/6 | — | — | yes | — | — |
| | weight of the | 1/12 | — | — | — | yes | — |
| | wastewater | 1/15 | — | — | — | — | — |
| | Second extraction; | 1/1 | yes | | — | — | — |
| | Usage amount of the | 1/4 | — | yes | — | — | — |
| | second extractant by | 1/15 | — | — | yes | — | yes |
| | weight of the | 1/45 | — | — | — | yes | — |
| | wastewater | 1/50 | — | — | — | — | — |
| | Stripping | | yes | yes | yes | yes | yes |
| Result | COD Value¹ (mg/L) | | 1,897 | 1,940 | 2,565 | 2,779 | 2,218 |
| | COD Removal Rate (%) | | 92.9 | 92.7 | 90.4 | 89.6 | 91.7 |
| | | | Comparative Example | | | | |
| | | | 1 | 2 | 3 | 4 | 5 |
| Process for | Acidification | | yes | yes | yes | yes | yes |
| reducing COD | First extraction; | 1/1 | yes | — | — | — | — |
| in wastewater | Usage amount of the | 1/4 | — | yes | — | — | yes |
| | first extractant by | 1/6 | — | — | yes | — | — |
| | weight of the | 1/12 | — | — | — | yes | — |
| | wastewater | 1/15 | — | — | — | — | — |
| | Second extraction; | 1/1 | yes | — | — | — | — |
| | Usage amount of the | 1/4 | — | yes | — | — | — |
| | second extractant by | 1/15 | — | — | yes | — | yes |
| | weight of the | 1/45 | — | — | — | yes | — |
| | wastewater | 1/50 | — | — | — | — | — |

| | | | | | | |
|---|---|---|---|---|---|---|
| | Stripping | no | no | yes | yes | yes |
| Result | COD Value¹ (mg/L) | 19,502 | 15,416 | 11,969 | 4,320 | 3,393 |
| | COD Removal Rate (%) | 27.0 | 42.3 | 55.2 | 83.8 | 87.3 |

Note 1:
the untreated wastewater had a COD value of 26,717 mg/L.

What is claimed is:

1. A method for reducing chemical oxygen demand of wastewater from preparation of 2-ethylhexanol, comprising steps of:
1) taking a high-boiling-point aldol mixture by-produced in the preparation of 2-ethylhexanol as a first extractant containing the following components with a total weight percent of 100%:
a) an alcohol or an aldehyde having 4 carbon atoms, 0-5 wt %;
b) an alcohol or an aldehyde having 8 carbon atoms, 20-25 wt %;
c) an alcohol or an aldehyde having at least 9 carbon atoms, 70-80 wt %; and
d) water, 0-1 wt %;
2) taking a low-boiling-point aldol mixture by-produced in the preparation of 2-ethylhexanol as a second extractant containing the following components with a total weight percent of 100%:
a) n-butanol, 60-70 wt %;
b) an alcohol or an aldehyde having 4 carbon atoms, 0-5 wt %;
c) an alcohol or an aldehyde having 8 carbon atoms, 10-20 wt %;
d) an alcohol or an aldehyde having at least 9 carbon atoms, 0-5wt %; and
e) water, 5-15wt %;
3) adding an inorganic acid to alkaline wastewaters produced from process for preparing of 2-ethylhexanol, to make the wastewater having a pH value of 0-4, wherein the inorganic acid is one or more selected from hydrochloric acid, sulfuric acid, phosphoric acid, and nitric acid;
4) extracting the wastewater acidized in Step 3) with the first extractant of Step 1), wherein a weight ratio of the first extractant to the wastewater ranges from 1:1 to 1:12;
5) extracting the acidized wastewater extracted in Step 4) with the second extractant of Step 2), wherein a weight ratio of the second extractant to the wastewater ranges from 1:1 to 1:45; and
6) introducing the acidified wastewater after extracted in Step 5) to a distillation column from top entering therein to meet a stripping medium entering the distillation column from bottom such that stripping happens at an operation temperature of 80-180° C. and a pressure of 0.5-4.5 kg/cm², thereby achieving a removal rate of COD in the wastewater of 89-93%, wherein the stripping medium for the stripping is steam or an inert gas.

2. The method for reducing chemical oxygen demand of wastewater as defined in claim 1, wherein the wastewater acidized in Step 3) has a pH value of 0-2.

3. The method for reducing chemical oxygen demand of wastewater as defined in claim 1, wherein the weight ratio of the first extractant to the wastewater in Step 4) ranges from 1:1 to 1:6.

4. The method for reducing chemical oxygen demand of wastewater as defined in claim 1, wherein the weight ratio of the second extractant to the wastewater in Step 5) ranges from 1:1 to 1:15.

5. The method for reducing chemical oxygen demand of wastewater as defined in claim 1, wherein in step 6) uses nitrogen as the stripping medium for stripping.

6. The method for reducing chemical oxygen demand of wastewater as defined in claim 1, wherein the stripping in step 6) is performed at an operation temperature ranging from 90° C. to 150° C.

7. The method for reducing chemical oxygen demand of wastewater as defined in claim 1, wherein the stripping in step 6) is performed at an operation temperature ranging from 90° C. to 130° C.

8. The method for reducing chemical oxygen demand of wastewater as defined in claim 6, wherein the stripping in step 6) is performed a pressure ranging from 0.5 kg/cm² to 2.75 kg/cm².

9. The method for reducing chemical oxygen demand of wastewater as defined in claim 7, wherein the stripping in step 6) is performed a pressure ranging from 1.0 kg/cm² to 2.4 kg/cm².
